(19) United States
(12) Patent Application Publication
(10) Pub. No.: US 2011/0080374 A1
(43) Pub. Date: Apr. 7, 2011

(54) OPTICAL TOUCH APPARATUS, OPTICAL TOUCH DISPLAY APPARATUS, AND LIGHT SOURCE MODULE

(75) Inventors: Hua-Te Feng, Hsin-Chu (TW); Chun-Chien Liao, Hsin-Chu (TW); Chia-Hung Yu, Hsin-Chu (TW)

(73) Assignee: CORETRONIC CORPORATION, Hsin-Chu (TW)

(21) Appl. No.: 12/875,103

(22) Filed: Sep. 2, 2010

(30) Foreign Application Priority Data
Oct. 6, 2009 (TW) 98133830

(51) Int. Cl. G06F 3/042; F21V 8/00

(52) U.S. Cl. 345/175; 362/621; 362/622

(57) ABSTRACT

An optical touch apparatus includes at least one light source, at least one light guide unit, at least one optical detector, and a light reducing structure. The light source is disposed beside a display area of a display and capable of providing a light beam. The light guide unit is disposed beside the display area and in a transmission path of the light beam. The light guide unit has a first surface, a second surface, and a light incident surface. The light beam is capable of entering the light guide unit through the light incident surface and being transmitted to a sensing space in front of the display area through the first surface. The optical detector is disposed beside the display area. The light reducing structure covers a portion of the first surface adjacent to the light incident surface.

### CROSS-REFERENCE TO RELATED APPLICATION

This application claims the priority benefit of Taiwan application serial no. 98133830, filed on Oct. 6, 2009. The entirety of the above-mentioned patent application is hereby incorporated by reference herein and made a part of specification.

### BACKGROUND OF THE INVENTION

1. Field of the Invention

The invention relates to a touch display apparatus, a touch apparatus, and a light source, and particularly to an optical touch display apparatus, an optical touch apparatus, and a light source module.

2. Description of Related Art

As information technique, wireless mobile communication, and information appliances have been rapidly developed, to achieve more convenience, more compact and light volume, and more user-friendly designs, various information products have changed from using conventional input devices such as key boards or mice to using touch panels. A touch panel may be attached to a display device to form a touch panel display device. Touch panels may be categorized into resistance touch panels, capacitance touch panels, optical touch panels, sound wave touch panels, and electromagnetic touch panels, etc, based on differences in the sensing principles.

In a resistance touch panel, a voltage drop is generated at a conductive place when two conductive layers originally separated from each other are connected with each other due to a single-point press. Then, a coordinate of the press on the panel is determined according to the position of the voltage drop. On the other hand, in a capacitance touch panel, a uniform electric field is formed between an inner conductive layer and an outer conductive layer. An electrostatic combination occurs when a conductor (e.g. a finger of human) touches the panel, then a slight variation of capacitance is generated. Hence, a coordinate of the touch position on the panel is determined according to the position of the variation of capacitance.

Besides, Taiwan Patent Application No. 98129124 discloses an optical touch apparatus. In the optical touch apparatus, a light guide bar, an invisible light source, and a light sensor are correspondingly disposed beside at least one side of a screen. When a user touches a position, the light sensor is capable of sensing no light source signal existing at the position such that a touch position is determined.

Taiwan Patent Publication No. 200700797 discloses a light emitting module including a light guide plate, a light emitting device, and a light absorbing material. Moreover, Taiwan Patent Publication No. 200841227 discloses an optical touch apparatus including a light source, a light guide module, and an image sensing module. The light source emits light into the light guide module, and the light guide module is used to transmit a moving state of an input device to the image sensing module.

### SUMMARY OF THE INVENTION

The invention provides an optical touch apparatus determining a touch position with well accuracy.

The invention provides an optical touch display apparatus determining a touch position with well accuracy.

The invention provides a light source module having uniform light emitting intensity.

Other objects and advantages of the invention may be further illustrated by the technical features broadly embodied and described as follows.

In order to achieve at least one of the objectives or other objectives, one embodiment of the invention provides an optical touch apparatus adapted to a display apparatus. The display apparatus has a display area. The optical touch apparatus includes at least one light source, at least one light guide unit, at least one optical detector, and a first light reducing structure. The light source is disposed beside the display area and capable of providing a light beam. The light guide unit is disposed beside the display area and in a transmission path of the light beam. The light guide unit has a first surface, a second surface, and a light incident surface. The second surface is opposite to the first surface. The light incident surface is connected with the first surface and the second surface. The light beam is capable of entering the light guide unit through the light incident surface and being transmitted to a sensing space in front of the display area through the first surface. The optical detector is disposed beside the display area to sense an intensity variation of the light beam in the sensing space. The first light reducing structure covers a portion of the first surface adjacent to the light incident surface to reduce an intensity of a portion of the light beam passing through the first light reducing structure.

Another embodiment of the invention provides an optical touch display apparatus including the display apparatus and the optical touch apparatus mentioned above.

An embodiment of the invention provides a light source module including the above light source, the above light guide unit, the above first light reducing structure, and a front frame. The front frame covers a portion of surfaces of the light guide unit, wherein the front frame is capable of being passed through by the light beam, and the first light reducing structure is disposed on at least one of the front frame and the light guide unit.

In summary, the embodiment or the embodiments of the invention may have at least one of the following advantages:

The embodiments of the invention adopt the first light reducing structure disposed on the light guide unit to reduce the excessive intensity of a portion of the light beam passing through the first surface adjacent to the light incident surface. Thus, uniform light emitting intensity of the light guide unit is achieved such that the optical touch apparatus and the optical touch display apparatus are capable of determining a touch position accurately.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of an optical touch display apparatus in an embodiment of the invention.

FIG. 2 is a schematic cross-sectional view of the optical touch display apparatus along line I-I of FIG. 1.

FIG. 3 is a perspective schematic view of the light guide unit and the light reducing structure of FIG. 1.

FIG. 4 is a top view of the light guide unit and the light source along x-direction of FIG. 3.

FIG. 5A is a schematic view illustrating the structure of a light source module in an embodiment of the invention.

FIG. 5B is a schematic cross-sectional view illustrating the light source module along line II-II of FIG. 5A.

FIG. 6A is a light emitting intensity curve diagram of a light source module without adopting a first light reducing structure and a second light reducing structure.

FIG. 6B is a light emitting intensity curve diagram of a light source module in an embodiment of the invention.

FIG. 7 is a schematic cross-sectional view of a light source module in another embodiment of the invention.

FIG. 8 is a schematic cross-sectional view of a light source module in another embodiment of the invention.

FIG. 9 is a schematic cross-sectional view of a light source module in another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components, are between “A” component and “B” component. Accordingly, the drawings and descriptions will be regarded as illustrative in nature and not as restrictive.

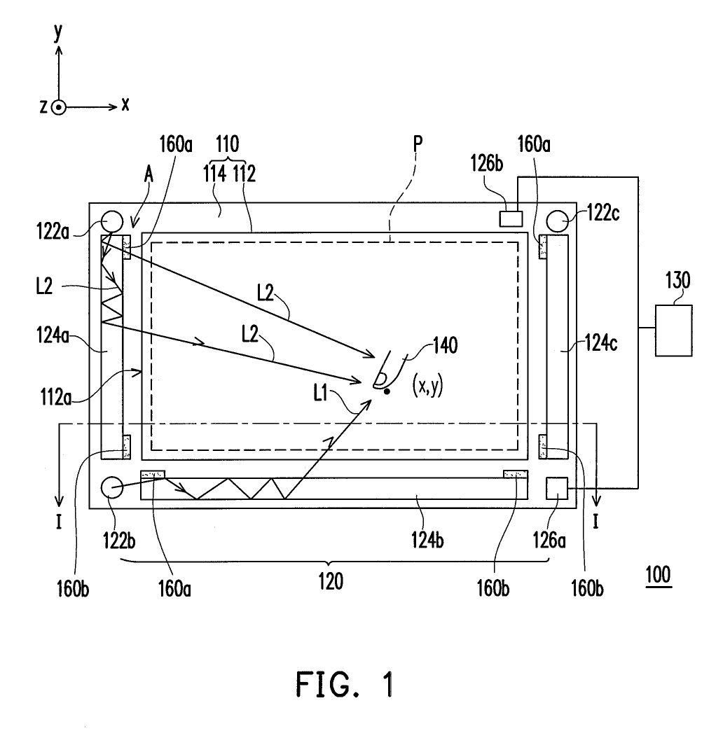

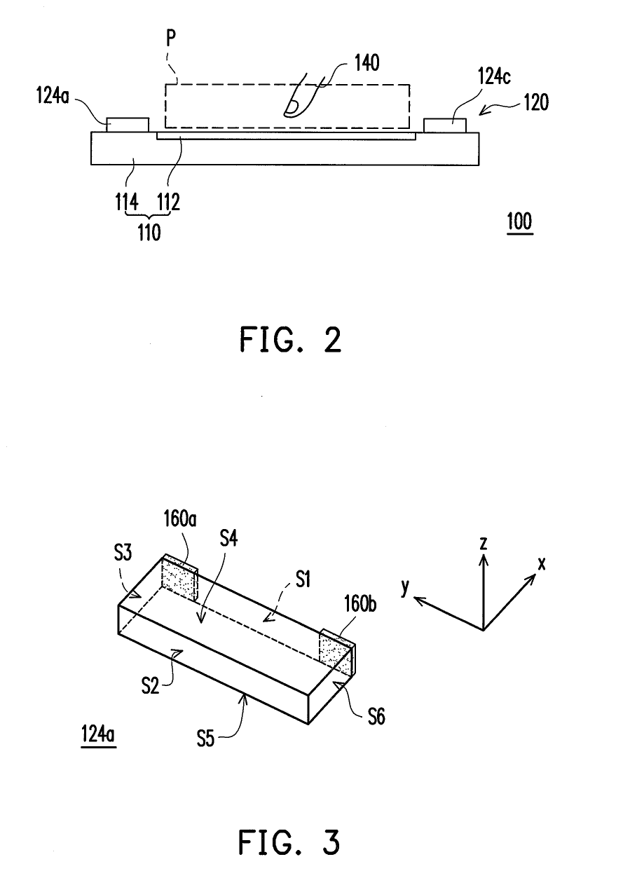

Referring to both FIGS. 1 and 2, the optical touch display apparatus 100 includes a display apparatus 110 and an optical touch apparatus 120. The display apparatus 110 has a display area 112, wherein a sensing space P is in front of the display area 112. Besides, the display apparatus 110 of the embodiment further includes an external frame 114. In the embodiment, the display area 112 is disposed in the external frame 114, and the optical touch apparatus 120 is disposed on the external frame 114.

As shown in FIG. 1, the optical touch apparatus 120 includes at least one light source 122b, at least one light guide unit 124b, and at least one optical detector 126a. The light source 122b is disposed beside the display area 112 and capable of providing a light beam L1. In the embodiment, the light beam L1 is invisible light for example, and the light source 122b is an infrared light emitting diode (IR-LED) for example.

Referring to FIG. 1, the light guide unit 124b is disposed in a transmission path of the light beam L1. On the other hand, the optical touch apparatus 120 of the embodiment includes a plurality of light sources, e.g. light sources 122a-122c (three are schematically shown in FIG. 1). The optical detector 126a is disposed beside the display area 112 to sense an intensity variation of a light beam (e.g. a light beam L2) in the sensing space P. Moreover, the optical touch apparatus 120 further includes a plurality of light guide units and a plurality of optical detectors, for example, light guide units 124a, 124b, and 124c (three are schematically shown in FIG. 1) and optical detectors 126a and 126b (two are schematically shown in FIG. 1). The light guide units 124a, 124b, and 124c are disposed at different sides of the display area 112 corresponding to the light sources 122a-122c, respectively. Each of the optical detectors 126a-126b is disposed beside the display area 112 and faces one of the light guide units 124a, 124b, and 124c. Specifically, the optical detector 126a is disposed beside the display area 112 and faces the light guide unit 124a, and the optical detector 126b is disposed beside the display area 112 and faces the light guide unit 124b. The optical detector 126a senses, for example, an intensity variation of the light beam L2 along y-direction transmitted from the light guide unit 124a. The optical detector 126b senses, for example, an intensity variation of the light beam L1 along x-direction transmitted from the light guide unit 124b.

Furthermore, the optical touch apparatus 120 of the embodiment further includes a processing unit 130 electronically connected with the optical detector 126a or the optical detector 126b. Referring to both FIG. 1 and FIG. 2, when a touch object 140 (e.g. a finger) enters the sensing space P, the processing unit 130 determines a position (x, y) of the touch object 140 relative to the display area 112 according to the intensity variations corresponding to different directions.

As shown in FIG. 3, the light guide unit 124a has a surface S1, a surface S2, and a light incident surface S3. The surface S2 is opposite to the surface S1. The light incident surface S3 is connected with the surface S1 and the surface S2. Referring to both FIG. 1 and FIG. 3, the light beam L2 from the light source 122a enters the light guide unit 124a through the light incident surface S3 and is transmitted to the sensing space P in front of the display area 112 through the surface S1. In other words, in the embodiment, the surface S1 of the light guide unit 124a is a light emitting surface.

Moreover, the light guide unit 124a of the embodiment further has a surface S4, a surface S5, and a surface S6. As shown in FIG. 3, the surface S4 of the light guide unit 124a is connected with the light incident surface S3, the surface S1, and the surface S2. The surface S5 is opposite to the surface S4 and connected with the light incident surface S3, the surface S1, and the surface S2. On the other hand, the surface S6 is opposite to the light incident surface S3.

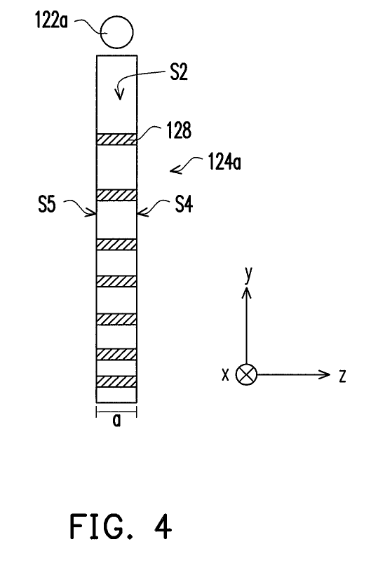

As shown in FIG. 4A, the surface S2 has a plurality of microstructures 128. A number density of the microstructures 128 close to the light source 122a is less than a number density of the microstructures 128 away from the light source 122a. Besides, the microstructures 128 are, for example, printing dots or etching dots. The printing dots are, for example protruding points or protruding patterns. The etching dots are, for example recessing points or grooves. The light beam L2 at the light emitting surface (i.e. surface S1) of the light guide unit 124a may emit uniformly by adjusting the number density of the microstructures 128 on the surface S2, such that the light guide unit 124a is capable of providing a uniform light source along y-direction. The width a of the light guide unit 124a along z-direction may be reduced so as to thin the optical touch apparatus 120.

Moreover, the surface S1, the surface S4, the surface S5, and the surface S6 (shown in FIG. 3) of the light guide unit 124a may have the mentioned-above microstructures 128 in another embodiment. In other words, in another embodiment, at least one of the surface S1, the surface S4, the surface S5, and the surface S6 has a plurality of microstructures 128 so as to enhance the uniformity of the irradiance of the light beam L2 at the light emitting surface (i.e. surface S1) of the light guide unit 124a along y-direction. On the other hand, the light guide units 124b and 124c of FIG. 1 may have the same structures as the structure of the light guide unit 124a. Thus, the light guide units 124b and 124c may respectively provide uniform light sources at other two sides of the display area 112, such that the uniformity of the irradiance in the sensing space P may be enhanced as well. Herein the irradiance (W/m²) is energy of light irradiating on a unit area per unit time. The structures of the light guide units 124b and 124c of the embodiment may be referred to the structure of the light guide unit 124a. Therefore, no further description is provided hereinafter.

Referring to both FIG. 1 and FIG. 3, in the embodiment, the light source 122a is disposed at a corner A of the display area 112, and the light guide unit 124a is disposed at a side 112a of the display area 112. In addition, the surface S1 faces the sensing space P. When the touch object 140 enters the sensing space P, the touch object 140 shields off a portion of the light beam L2 transmitted from the light guide unit 124a, such that the optical detector 126a senses an intensity variation of the light beam L2 along y-direction. In other words, the optical detector 126a senses a dark point along y-direction, such that coordinate y of a touch position is determined according to the dark point. Similarly, the touch object 140 also shields off a portion of the light beam L1 transmitted from the light guide unit 124b, such that the optical detector 126b senses another intensity variation of the light beam L1 along x-direction. In other words, the optical detector 126b senses a dark point along x-direction, such that coordinate x of the touch position is determined according to the dark point. Then, the processing unit 130 determines the position (x, y) of the touch object 140 relative to the display area 112 according to the intensity variations along the two directions.

By properly rotating the optical detector 126b, the optical detector 126b may sense the intensity variation of light beam L2 transmitted from the light guide unit 124a along y-direction in the sensing space P. In other words, in another embodiment, the optical detector 126a and the optical detector 126b may be able to respectively sense the intensity variations along x-direction and y-direction in the sensing space P according to the location and the rotating degree. Thus, the position (x, y) of the touch object 140 is determined according to the intensity variations along different directions respectively sensed by the optical detector 126a and the optical detector 126b. In other words, the locations of the optical detector 126a and the optical detector 126b are not limited to the locations as shown in FIG. 1, and may be varied according to the actual requirements.

In general, in the light guide units 124a, 124b, and 124c, the intensity of the light beams L1 and L2 transmitted from a portion of the surface S1 adjacent to the light incident surface S3 and a portion thereof adjacent to the surface S6 is larger, and therefore non-uniform light emitting intensity is generated. As a result, the accuracy of the optical detectors 126a and 126b is affected. In order to solve the problem, a first light reducing structure 160a and a second light reducing structure 160b are adopted. The first light reducing structure 160a covers a portion of the surface S1 adjacent to the light incident surface S3 to reduce an intensity of a portion of the light beams L1 and L2 passing through the first light reducing structure 160a. Besides, the second light reducing structure 160b covers a portion of the surface S1 adjacent to the surface S6 to reduce a portion of an intensity of the light beam passing through the second light reducing structure 160b. In the embodiment, the first light reducing structure 160a and the second light reducing structure 160b are, for example, coatings coated on the surface S1. The coating is, for example, paint including a pigment, and the pigment is capable of shielding off at least a portion of the light beams L1 and L2. Hence, in the light guide units 124a, 124b, and 124c, the intensity of the light beams L1 and L2 transmitted from portions of the surface S1 adjacent to the light incident surface S3 and adjacent to the surface S6 is close to the intensity of the light beams L1 and L2 transmitted from the remaining portion of the surface S1. As a result, the uniformity of the total light emitting intensity is improved, such that the accuracy of the optical detectors 126a and 126b is improved. Thus, the accuracy of the touch position determined by the optical detectors 126a and 126b is enhanced.

In order to enhance the uniformity of the total light emitting intensity, a reduced degree of the intensity of the first light reducing structure 160a and a reduced degree of the second light reducing structure 160b may be varied with intensities of the light beams L1 and L2 changed with different positions on the first light reducing structure 160a and the second light reducing structure 160b struck by the light beams L1 and L2, and the reduced degree of the intensity is larger at a position with a greater intensity. For example, the reduced degree of the intensity at a position on the first light reducing structure 160a adjacent to the light incident surface S3 is higher than the reduced degree of the intensity at a position on the first light reducing structure 160a away from the light incident surface S3. Besides, the reduced degree of the intensity at a position on the second light reducing structure 160b adjacent to the surface S6 is larger than the reduced degree of the intensity at a position on the first light reducing structure 160b away from the surface S6. The reduced degree of the intensity may be adjusted by setting parameters of the first light reducing structure 160a and the second light reducing structure 160b. For example, in order to achieve a position with greater reduced degree of intensity, the thicknesses of the first light reducing structure 160a and the second light reducing structure 160b are greater, the concentrations of the pigments thereof are higher, or the numbers of coating layers thereof are more. Alternatively, any combinations of the above means may be used. On the contrary, in order to achieve a position with less reduced degree, the thicknesses of the first light reducing structure 160a and the second light reducing structure 160b are thinner, the concentrations of the pigments of thereof are lower, or the numbers of coating layers thereof are less. Alternatively, any combinations of the above means may be used.

The first light reducing structure 160a and the second light reducing structure 160b of the embodiment of the invention are not limited to coatings. In another embodiment, the first light reducing structure 160a and the second light reducing structure 160b may be a plurality of light scattering microstructures disposed on the surface S1. The light scattering microstructures are, for example a plurality of protruding points, recessing points, protruding patterns, grooves, or light scattering particles on the surface S1, and the light scattering microstructures scatter the light beam L2 to reduce the intensity of the light beam L2. Furthermore, the second light reducing structure 160b may not be necessary for the optical touch apparatus 120 of the embodiment of the invention. In another embodiment, as long as the lengths of the light guide units 124a, 124b, and 124c are long enough, such that the intensity of the light beam transmitted from the portion of the surface S1 adjacent to the surface S6 is not too strong, and there is no need to dispose the second light reducing structure 160b.

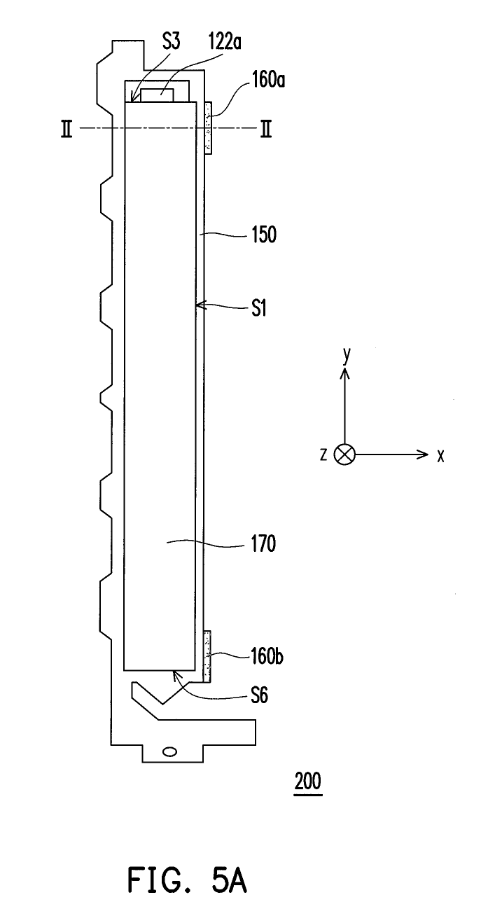

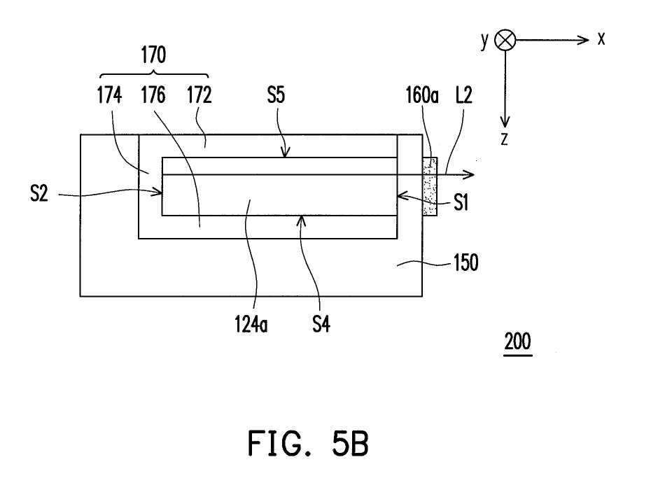

Referring to FIG. 5A and FIG. 5B, the light source module 200 of the embodiment includes the light source 122a, the light guide unit 124a, the first light reducing structure 160a, and the second light reducing structure 160b mentioned above, and further a front frame 150. The light source module 200 of the embodiment is similar to a combination of the light guide unit 124a, the light source 122a, the first light reducing structure 160a, and the second light reducing structure 160b in FIG. 1. The combination thereof may be replaced by the light source module 200 of the embodiment so as to form a different type of optical touch apparatus and optical touch display apparatus. Differences between the structure of the light source module 200 of the embodiment and the structure depicted in FIG. 1 are illustrated in detail below. To be easily read, the light guide unit 124a of FIGS. 5A and 5B are depicted as a mirror image of the light guide unit 124a of FIG. 1 with respect to x-y plane. That is, the original positive z-direction is changed to negative z-direction. However, each of the surfaces of the light guide unit 124a and the corresponding relations of x, y and z directions are able to be adjusted according to the position of the light guide unit 124a relative to the display area 112 or actual requirements, and the scope of the invention is not limited to FIG. 1, FIG. 5A, and FIG. 5B.

The front frame 150 of the embodiment covers a portion of surfaces of the light guide unit 124a. In the embodiment, the front frame 150 covers, for example, the light incident surface S3, the surface S1, the surface S2, the surface S4, and the surface S6. However, in another embodiment, the front frame 150 may cover at least one of the light incident surface S3, the surface S1, the surface S2, the surface S4, and the surface S6. The front frame 150 is capable of being passed through by the light beam L2. A color master may be added into the front frame 150, such that the front frame 150 is non-transparent. Thus, the artistry-featuring look of the optical touch display apparatus 100 is enhanced. An infrared ray is capable of passing through the color master mentioned above. That is to say, the light beam L2 is capable of passing through the front frame 150 and traveling to the sensing space P of FIG. 1, such that the sensing function of the optical detectors 126a and 126b may not be affected. Furthermore, in the embodiment, the front frame 150 is disposed between the surface S1 and the first light reducing structure 160a, and the front frame 150 covers at least the surface S1. In addition, the first light reducing structure 160a covers, a portion of the surface S1 adjacent the light incident surface S3. In the embodiment, the first light reducing structure 160a is a coating coated on a surface of the front frame 150, and the structure of the first light reducing structure 160a is substantially the same as the structure of the coating coated of the embodiment depicted in FIG. 1.

Besides, the light source module 200 may further include a reflective unit 170 covering at least one of the surface S2, the surface S4, the surface S5, and the surface S6 (as shown in FIG. 3). In the embodiment, the reflective unit 170 covers the surface S2, the surface S4, and the surface S5. Specifically, the reflective unit 170 includes reflective sheets 172, 174, and 176 respectively covering the surface S5, the surface S2 and the surface S4.

Since the light source module 200 of the embodiment has the first light reducing structure 160a and the second light reducing structure 160b, the intensity of the light beam L2 transmitted from portions of the surface S1 of the light guide unit 124a adjacent to the light incident surface S3 and adjacent to the surface S6 is close to the intensity of the light beam L2 transmitted from the remaining portion of the surface S1. Thus, the uniformity of the total light emitting intensity is enhanced, such that the optical detectors 126a and 126b is capable of determining the touch position precisely. Figures from experiments are shown below to illustrate the effect of the light source module 200. The light source module 200 of the embodiment is able to replace the combination of the light guide unit 124a, the light source 122a, the first light reducing structure 160a, and the second light reducing structure 160b in FIG. 1, and may also replace the combination of the light guide unit 124c, the light source 122c, the first light reducing structure 160a, and the second light reducing structure 160b in FIG. 1. Notably, the direction of each of the surfaces of the light guide unit 124a of the light source module 200 respectively facing has to be adjusted correspondingly, such that the surface S1 faces the sensing space P, and the light incident surface S3 faces the light sources (e.g. the light source 122b or the light source 122c).

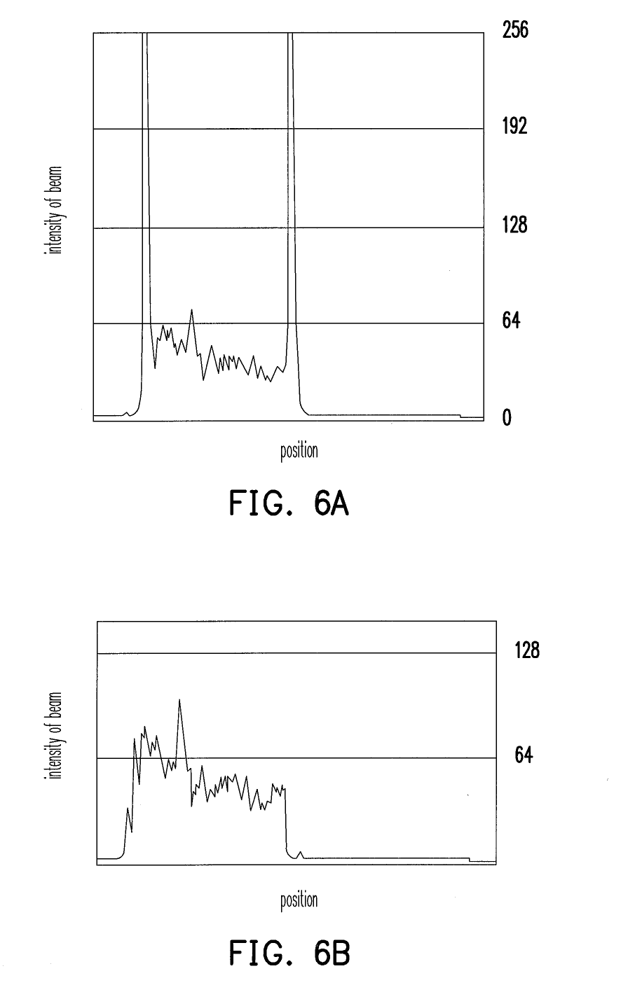

Referring to FIGS. 6A and 6B, the horizontal axis represents y-direction (i.e. the extending direction of the light guide unit 124a), and the vertical axis represents the intensity of light beam L2 transmitted from the surface S1. As shown in FIG. 6A, the intensity of the light beam L2 transmitted from two ends of the surface S1 (i.e. portions adjacent to the light incident surface S3 and the surface S6) is too strong since the first light reducing structure 160a and the second light reducing structure 160b are not adopted. As a result, the accuracy of the optical detectors is affected. Referring to FIG. 6B, because the light source module 200 of the embodiment adopts the first light reducing structure 160a and the second light reducing structure 160b, the uniformity of the total light emitting intensity is enhanced, such that the optical detectors is capable of determining the touch position precisely.

When the length along y-direction of the light guide unit 124a is long enough, the first light reducing structure 160a may be adopted alone without adopting the second light reducing structure 160b.

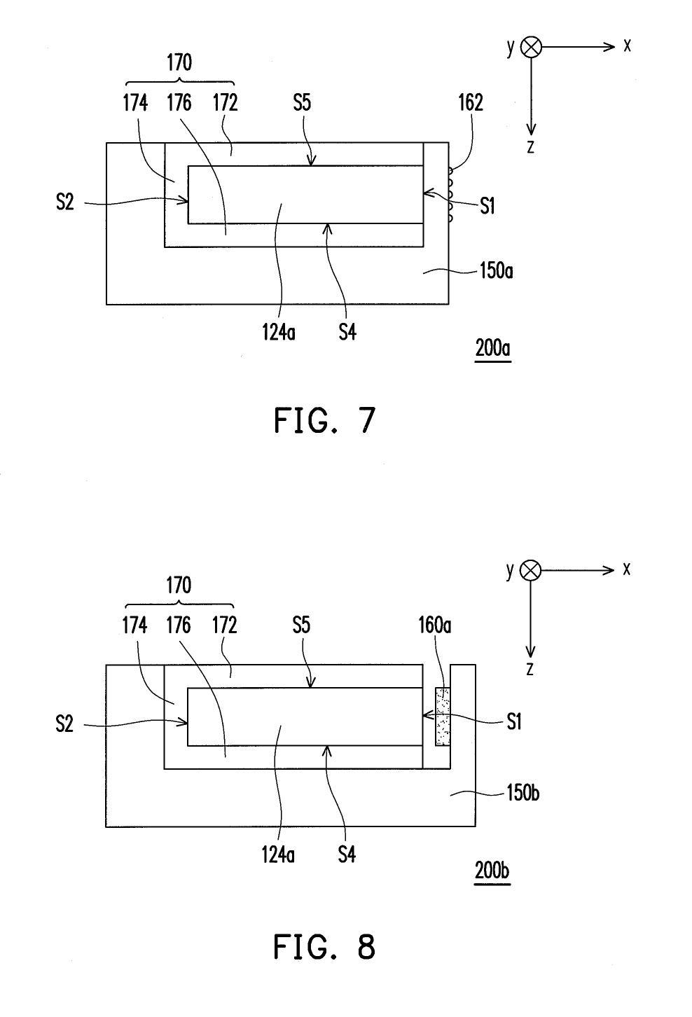

Referring to FIG. 7, the light source module 200a of the embodiment is similar to the light source module 200 of FIG. 5B, and the difference between the light source module 200a and the light source module 200 is that the first light reducing structure 162 of the light source module 200a of the embodiment is a plurality of light scattering structures disposed on the surface of the front frame 150a. In the embodiment, the light scattering structures are, for example protruding points. However, in another embodiment, the light scattering structures may be recessing points, protruding patterns, grooves, or light scattering particles on the surface of the front frame 150a. Moreover, the second light reducing structure (not shown in FIG. 7) of the light source module 200a may be also a plurality of light scattering structures.

Referring to FIG. 8, the light source module 200b of the embodiment is similar to the light source module 200 in FIG. 5B, and the difference between these two light source module is described as below. In the embodiment, the first light reducing structure 160a of the light source module 200b is disposed between the surface S1 and the front frame 150b. In the embodiment, the first light reducing structure 160a is a coating coated on the surface of the front frame 150b. In addition, the second light reducing structure (not shown in FIG. 8) of the light source module 200b may be disposed between the surface S1 and the front frame 150b. The second light reducing structure may be, for example a coating coated on the surface of the front frame 150b.

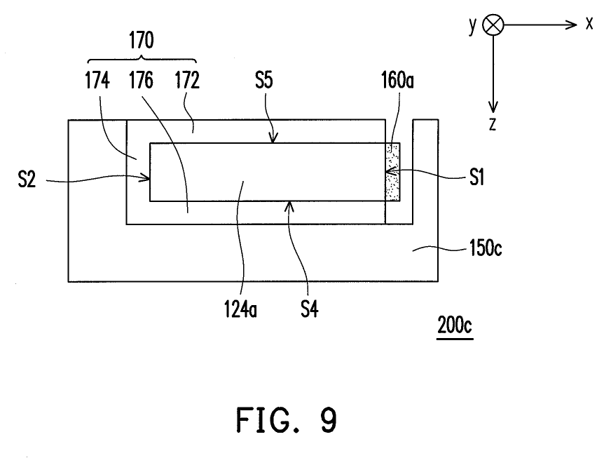

Referring to FIG. 9, the light source module 200c of the embodiment is similar to the light source module 200b of FIG. 8, and the difference between the light source module 200c and the light source module 200b is that the first light reducing structure 160a of the light source module 200c of the embodiment is a coating coated on the surface S1. Moreover, in the embodiment, the second light reducing structure (not shown in FIG. 9) may be also a coating coated on the surface S1.

The position of the first light reducing structure 160a of the embodiment of the invention is not limited to being disposed on one of the positions as depicted in FIGS. 5B, 8 and 9. In another embodiment, three first light reducing structures 160a may be respectively disposed on the positions depicted in FIGS. 5B, 8 and 9, or two first light reducing structures 160a may be respectively disposed on two of the positions depicted in FIGS. 5B, 8 and 9. Similarly, so the second light reducing structure 160b does, and therefore detailed description thereof is not repeated.

In summary, the embodiment or the embodiments of the invention may have at least one of the following advantages:

The embodiments of the invention adopt the first light reducing structure disposed on the light guide unit to reduce the excessive intensity of the light beam passing through the portion of the surface S1 adjacent to the light incident surface. Thus, the total light emitting intensity of the light guide unit is uniform, such that the optical touch apparatus and the optical touch display apparatus are capable of determining a touch position accurately. Besides, the second light reducing structure of the embodiment of the invention is further adopted to cover the portion of the surface S1 adjacent to the surface S6 so as to reduce the excessive intensity of light beam transmitted from the portion of the surface S1 adjacent to the surface. S6. Hence, the total light emitting intensity of the light guide unit is uniform.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical touch apparatus adapted to a display apparatus, the display apparatus having a display area, the optical touch apparatus comprising:
at least one light source, disposed beside the display area and capable of providing a light beam;
at least one light guide unit, disposed beside the display area and in a transmission path of the light beam, the light guide unit having:
a first surface;
a second surface, opposite to the first surface; and
a light incident surface, connected with the first surface and the second surface, wherein the light beam is capable of entering the light guide unit through the light incident surface and being transmitted to a sensing space in front of the display area through the first surface;
at least one optical detector disposed beside the display area to sense an intensity variation of the light beam in the sensing space; and
a first light reducing structure, covering a portion of the first surface adjacent to the light incident surface to reduce an intensity of a portion of the light beam passing through the first light reducing structure.

2. The optical touch apparatus of claim 1, wherein a reduced degree of the intensity of the first light reducing structure varies with intensity of the light beam changed with different positions on the first light reducing structure struck by the light beam, and the reduced degree of the intensity is larger at a position with greater intensity of the light beam.

3. The optical touch apparatus of claim 1, wherein a reduced degree of the intensity of the first light reducing structure at a position on the first light reducing structure adjacent to the light incident surface is larger than the reduced degree of the intensity of the first light reducing structure at a position on the first light reducing structure away from the light incident surface.

4. The optical touch apparatus of claim 1, further comprising a front frame covering a portion of surfaces of the light guide unit, wherein the front frame is capable of being passed through by the light beam.

5. The optical touch apparatus of claim 4, wherein the front frame covers at least the first surface of the light guide unit, and the first light reducing structure is disposed between the first surface and the front frame.

6. The optical touch apparatus of claim 4, wherein the front frame covers at least the first surface of the light guide unit, and the front frame is disposed between the first surface and the first light reducing structure.

7. The optical touch apparatus of claim 4, wherein the first light reducing structure is a coating coated on a surface of the front frame or a plurality of light scattering microstructures disposed on the surface of the front frame.

8. The optical touch apparatus of claim 1, further comprising a second light reducing structure, wherein the light guide unit further has:
a third surface, connected with the light incident surface, the first surface, and the second surface;
a fourth surface, opposite to the third surface, and connected with the light incident surface, the first surface, and the second surface; and
a fifth surface, opposite to the light incident surface,
wherein the second light reducing structure covers a portion of the first surface adjacent to the fifth surface to reduce an intensity of a portion of the light beam passing through the second light reducing structure.

9. The optical touch apparatus of claim 1, wherein the first light reducing structure is a coating coated on the first surface of the light guide unit or a plurality of light scattering microstructures disposed on the first surface of the light guide unit.

10. An optical touch display apparatus, comprising:
a display apparatus, having a display area; and
an optical touch apparatus, comprising:
at least one light source, disposed beside the display area and capable of providing a light beam;
at least one light guide unit, disposed beside the display area and in a transmission path of the light beam, the light guide unit having:
a first surface;
a second surface, opposite to the first surface; and
a light incident surface, connected with the first surface and the second surface, wherein the light beam is capable of entering the light guide unit through the light incident surface and being transmitted to a sensing space in front of the display area through the first surface;
at least one optical detector, disposed beside the display apparatus to sense an intensity variation of the light beam in the sensing space; and
a first light reducing structure, covering a portion of the first surface adjacent to the light incident surface to reduce an intensity of a portion of the light beam passing through the first light reducing structure.

11. The optical touch display apparatus of claim 10, wherein a reduced degree of the intensity of the first light reducing structure varies with intensity of the light beam changed with different positions on the first light reducing structure struck by the light beam, and the reduced degree of the intensity is larger at a position with a greater intensity of the light beam.

12. The optical touch display apparatus of claim 10, wherein a reduced degree of the intensity of the first light reducing structure at a position on the first light reducing structure adjacent to the light incident surface is larger than the reduced degree of the intensity of the first light reducing structure at a position on the first light reducing structure away from the light incident surface.

13. The optical touch display apparatus of claim 10, wherein the optical touch apparatus further comprises a front frame covering a portion of surfaces of the light guide unit, wherein the front frame is capable of being passed through by the light beam.

14. The optical touch display apparatus of claim 13, wherein the front frame covers at least the first surface of the light guide unit, and the first light reducing structure is disposed between the first surface and the front frame.

15. The optical touch display apparatus of claim 13, wherein the front frame covers at least the first surface of the light guide unit, and the front frame is disposed between the first surface and the first light reducing structure.

16. The optical touch display apparatus of claim 13, wherein the first light reducing structure is a coating coated on a surface of the front frame or a plurality of light scattering microstructures disposed on the surface of the front frame.

17. The optical touch display apparatus of claim 10, further comprising a second light reducing structure, wherein the light guide unit further has:
a third surface, connected with the light incident surface, the first surface, and the second surface;
a fourth surface, opposite to the third surface, and connected with the light incident surface, the first surface, and the second surface; and
a fifth surface, opposite to the light incident surface,
wherein the second light reducing structure covers a portion of the first surface adjacent to the fifth surface to reduce an intensity of a portion of the light beam passing through the second light reducing structure.

18. The optical touch display apparatus of claim 10, wherein the first light reducing structure is a coating coated on the first surface of the light guide unit or a plurality of light scattering microstructures disposed on the first surface of the light guide unit.

19. A light source module, comprising:
at least one light source capable of providing a light beam;
a light guide unit, disposed in a transmission path of the light beam, the light guide unit having:
a first surface;
a second surface, opposite to the first surface; and
a light incident surface, connected with the first surface and the second surface, the light beam is capable of entering the light guide unit through the light incident surface and being transmitted to an external environment through the first surface;
a first light reducing structure, covering a portion of the first surface adjacent to the light incident surface to reduce an intensity of a portion of the light beam passing through the first light reducing structure; and
a front frame, covering a portion of surfaces of the light guide unit, wherein the front frame is capable of being passed through by the light beam, and the first light reducing structure is disposed on at least one of the front frame and the light guide unit.

20. The light source module of claim 19, wherein the first light reducing structure is a coating coated on a surface of the front frame or a plurality of the light scattering microstructures disposed on the surface of the front frame.

21. The light source module of claim 19, further comprising a second light reducing structure, wherein the light guide unit further has:
a third surface, connected with the light incident surface, the first surface, and the second surface;
a fourth surface, opposite to the third surface, and connected with the light incident surface, the first surface, and the second surface; and
a fifth surface, opposite to the light incident surface,
wherein the second light reducing structure covers a portion of the first surface adjacent to the fifth surface to reduce an intensity of a portion of the light beam passing through the second light reducing structure.
